(19) United States
(12) Patent Application Publication
(10) Pub. No.: US 2003/0102267 A1
(43) Pub. Date: Jun. 5, 2003

(54) Process for purification of aromatic monomers

(76) Inventors: Dae K. Kim, Naperville, IL (US); Larry C. Satek, St. Charles, IL (US); Michael J. Foral, Aurora, IL (US)

Correspondence Address: CAROL WILSON, BP AMERICA INC., MAIL CODE 5 EAST, 4101 WINFIELD ROAD, WARRENVILLE, IL, 60555, US

(21) Appl. No.: 09/998,077

(22) Filed: Nov. 30, 2001

(51) Int. Cl. C02F 1/42

(52) U.S. Cl. 210/670

(57) ABSTRACT

Processes using heterogeneous adsorbents are disclosed for purification of aromatic monomers such as are typically produced by dehydrogenation of suitable benzenoid hydrocarbons, by passing a steam of ethylenically unsaturated aromatic monomer and impurities comprising at least one substituted aromatic compound having the same or similar carbon content in which a substituent moiety is acetylenically unsaturated, through a particulate bed of predominantly a support material having high surface area on which is dispersed at least one metallic element. Selective adsorption and/or complexing of the contained impurities with the adsorbent is continued until levels of a selected impurity in the effluent stream increase to a predetermined level. Thereafter the resulting bed of adsorbent is regenerated in the presence of a reducing gas containing dihydrogen to effect release of the contained impurities from the adsorbent.

### FIELD OF THE INVENTION

The field of this invention relates to use of heterogeneous adsorbents in purification of relatively impure aromatic monomers such as styrene. More particularly, this invention concerns recovery of ethylenically unsaturated aromatic monomers free of acetylenically unsaturated aromatic impurities by passing a process stream through a particulate bed of heterogeneous adsorbent comprising a metal supported on a high surface area carrier, under conditions suitable for adsorption of the impurities. Beneficially, the resulting monomers have reduced levels of substituted aromatic hydrocarbons in which the substituent moiety has at least one triple bond, i.e., a hydrocarbon moiety characterized by the sharing of six electrons between two carbon atoms.

Processes according to this invention are particularly useful where the aromatic monomer being purified is styrene formed by dehydrogenation of ethylbenzene which, for example, contain undesirable levels of phenyacetylene (ethynylbenzene) and optionally small amounts of olefinic impurities, and/or other organic components which are, typically, impurities in aromatic monomers.

### BACKGROUND OF THE INVENTION

As is well known, styrene is the most important member of a series of substituted aromatic monomers in which the substituent moiety is ethylenically unsaturated, i.e., a series of hydrocarbon moieties characterized by having a double bond of four shared electrons between two carbon atoms. The simplest member of the series, styrene, may be the largest volume aromatic monomer produced today. Ethylenically unsaturated aromatic monomers including, importantly, styrene, vinyl toluene, t-butylstyrene, divinyl benzene, α-methylstyrene, diacetone-acrylamide, chlorostyrene, hydroxyethyl acrylate, hydroxypropyl acrylate, methacrylate, methyl methacrylate, butyl methacrylate and butyl acrylate, are converted to a multitude of intermediate and end products on a large scale, mainly polymeric materials.

Recently the trend in the hydrocarbon processing industry is to reduce commercially acceptable levels of impurities in major substituted aromatic monomer streams. Need for purity improvements is directly related to increasing use of higher activity catalysts for production of polymeric resins.

Styrene, for example, is obtained primarily by alkylation of benzene with ethylene and subsequent dehydrogenation of the resulting ethylbenzene. Because most of the ethylbenzene produced commercially is converted to styrene, ethylbenzene and styrene plants are typically installed together with matching capacities. The catalytic alkylation is exothermic e.g. at about 95° C., and the dehydrogenation is endothermic, e.g. at about 630° C. Typically, energy economies are realized by advantageously integrating the energy flows between the alkylation and dehydrogenation sections in a commercial ethylbenzene-styrene complex.

Styrene is a commodity chemical traded in large volumes world-wide. The minimum purity dictated by the market is usually about 99.8 percent. In anticipation of future demand, a process to produce high purity styrene at a small incremental investment can gain marketing advantages. In particular, reduction in the concentration of phenylacetylene, a deleterious co-product of the ethylbenzene dehydrogenation, should enhance a manufacture's position in the tightly competitive styrene market. An alternative to adsorption is catalytic hydrogenation. However, catalytic hydrogenation has several disadvantages, i.e. it is expensive and difficult to control due the non-selective hydrogenation of styrene to ethylbenzene.

Processes using heterogeneous adsorbents are known for purification of olefins, such as are typically produced by thermal cracking of suitable hydrocarbon feedstocks, by passing a stream of olefin through a particulate bed of support material on which is dispersed a metallic element. U.S. Pat. No. 6,080,905 and U.S. Pat. No. 6,124,517 in the name of Mark P. Kaminsky, Shiyou Pei, Richard A Wilsak, and Robert E. Whittaker describe adsorption which is carried out in an essentially dihydrogen-free atmosphere within the bed. Adsorption of the contained acetylenic impurities is continued until levels of acetylenic impurities in the effluent stream increase to a predetermined level. Thereafter the resulting bed of adsorbent is regenerated using hydrogen to effect release of the contained acetylenic impurities from the adsorbent. However, there remains a need to increase the capacity of adsorbents for acetylenics whereby the useful life of the adsorbent bed between regenerations is increased.

It is therefore a general object of the present invention to provide an improved process which overcomes the aforesaid problem of prior art methods, for production of substituted aromatic monomers free of acetylenically unsaturated aromatic impurities which monomers can be used for manufacture of polymeric materials using higher activity catalysts.

More particularly, it is an object of the present invention to provide an improved method for purification of styrene. In particular, reduction in the concentration of phenylacetylene, a deleterious co-product of the ethylbenzene dehydrogenation, by passing the impure styrene stream through a particulate bed of heterogeneous adsorbent comprising a metal supported on a high surface area carrier, under conditions suitable for adsorption of the impurities.

It is another object of the present invention to provide an improved aforesaid purification method that employs an adsorbent that, even after a substantial period of aging, exhibits ability to withstand repeated regenerations and yet retain useful adsorption capacity.

Other objects and advantages of the invention will become apparent upon reading the following detailed description and appended claims.

### SUMMARY OF THE INVENTION

Economical processes are disclosed for purification of an aromatic monomer produced by catalytic dehydrogenation of an alkylated aromatic compound. Processes of this invention comprise: providing a feedstock comprising at least one substituted aromatic monomer of from 8 to about 18 carbon atoms in which a substituent moiety is ethylenically unsaturated and impurities comprising at least one substituted aromatic compound having the same or similar carbon content in which a substituent moiety is acetylenically unsaturated in an amount of more than about 100 parts per million based upon the total amount of aromatic monomer present and optionally saturated hydrocarbon compounds; passing the feedstock through a particulate bed of adsorbent comprising predominantly a support material having high surface area on which is dispersed at least one metallic element in the zero valent state selected from the group consisting of chromium, iron, cobalt, nickel, copper, ruthenium, palladium, silver and platinum, to effect, under conditions suitable for adsorption within the bed, to effect, in the presence of an essentially dihydrogen-free atmosphere within the bed, selective adsorption and/or complexing of the contained impurities with the adsorbent, and thereby obtain purified effluent which contains less than about 100 parts per million of the acetylenically unsaturated impurity; and thereafter regenerating the resulting bed of adsorbent in the presence of a reducing gas comprising dihydrogen (molecular hydrogen) to effect release of the contained impurities from the adsorbent. Preferably the aromatic monomer is selected from the group consisting of styrene and vinyl toluene, more preferably aromatic monomer is styrene.

An aspect of special significance is the separation of aromatic impurities from styrene containing small amounts of phenyacetylene, i.e., less than about 1000 parts per million by weight base upon the total amount of styrene present, and optionally containing ethylbenzene, and thereby provide, advantageously, purified product containing less than about 50 parts per million by weight, preferably containing less than about 20 parts per million by weight, more preferably containing less than about 10 parts per million by weight and frequently even less than about 5 parts per million by weight.

In another aspect the invention is a process for recovery of a high purity styrene monomer from a feedstock produced by catalytic dehydrogenation of ethylbenzene which process comprises: passing a feedstock comprising predominantly styrene and impurities comprising phenyacetylene in an amount of more than about 100 parts per million based upon the total amount of styrene present and optionally ethylbenzene through a particulate bed of adsorbent comprising predominantly a support material selected from the group alumina, silica, active carbon, clay and zeolites having surface area in a range of from about 10 to about 2,000 square meters per gram as measured by the BET gas adsorption method, on which is dispersed at least one metallic element selected from the group consisting of chromium, iron, cobalt, nickel, copper, ruthenium, palladium, silver and platinum, to provide an effluent stream from the bed; effecting, in the presence of and essentially dihydrogen-free atmosphere within the bed, selective and reversible adsorption and/or complexing of the contained impurities with the adsorbent, until levels of the phenyacetylene impurity in the effluent stream increase to a predetermined level in a range downward from about 20 parts per million by volume; and thereafter regenerating the resulting bed of adsorbent in the presence of a reducing gas comprising dihydrogen to effect release of the contained impurities from the adsorbent.

In yet another aspect the invention is a process for recovery of a high purity aromatic monomer from a feedstock produced by catalytic dehydrogenation of an alkylated benzene which process comprises: passing a feedstock comprising at least about 98 percent by volume of an aromatic monomer selected from the group consisting of styrene, methylphenylethylene, vinyl toluenes, vinyl chlorobenzene, n-propylbenzene, divinylbenzene and t-butylbenzene, and dehydrogenated impurities comprising one or more members of the group consisting of phenylacetylene, methyl phenylacetylene, (vinylphenyl)acetylene, t-butylphenyl)acetylene, tolylacetylene and chloroacetylene, in an amount of about 100 to about 1000 parts per million based upon the total amount of monomer present through a particulate bed of adsorbent comprising predominantly through a bed of adsorbent which is free of a substantial amount of carbon monoxide, the adsorbent comprising at least about 90 weight percent of gamma alumina having surface area in a range of from about 150 to about 350 square meters per gram as measured by the BET gas adsorption method, on which is dispersed is at least one element selected from the group consisting of iron, cobalt, nickel, copper, palladium, silver and platinum, in the zero valent state, to effect, under conditions suitable for adsorption within the bed, selective adsorption and/or complexing of the contained impurities with the adsorbent, thereby obtaining an effluent steam of feedstock which contains less than about 10 parts per million by volume of the dehydrogenated impurities; effecting, in the presence of an essentially dihydrogen-free atmosphere within the bed, selective adsorption and/or complexing of one or more of the contained impurities with the adsorbent, until levels of the impurities in the effluent stream increase to a limiting level in a range downward from about 10 parts per million by weight; and thereafter regenerating the resulting bed of adsorbent in the presence of a reducing gas comprising dihydrogen which reducing gas is free of a substantial amount of carbon monoxide, to effect release of the impurities from the adsorbent.

A preferred class of adsorbents useful in processes according the invention, comprises at least about 90 weight percent of a gamma alumina having surface area in a range of from about 80 to about 500 square meters per gram as measured by the BET gas adsorption method. More preferred are the adsorbent which comprises at least about 90 weight percent of a gamma alumina having surface area in a range of from about 150 to about 350 square meters per gram as measured by the BET gas adsorption method, and wherein the metal dispersed on the support material is palladium, and the absorbent has a palladium content in a range of from about 0.01 to about 10 percent based on the total weight of the adsorbent.

For a more complete understanding of the present invention, reference should now be made to the embodiments illustrated in greater detail and described below by way of examples of the invention.

### BRIEF DESCRIPTION OF THE INVENTION

Processes of this invention are particularly suitable for use in recovery of ethylenically unsaturated aromatic monomers free of acetylenically unsaturated aromatic impurities produced, generally, by catalytic dehydrogenation of alkyl aromatic hydrocarbons.

Suitable unsaturated aromatic compounds for purification according to the present invention, have eight to about twelve carbon atoms, preferably eight to about ten carbon atoms. Aromatic monomers of most interest with regard to purification by the method of the present invention include styrene, divinylbenzene, vinyl toluene, t-butyl styrene, p-methylstyrene and n-propylbenzene, more preferably styrene and vinyl toluene and most preferably styrene.

The separation of phenylacetylene from crude styrene which may be contained in admixture with other acetylenically unsaturated aromatic impurities and/or other normally liquid aromatic compounds, such as of ethylbenzene, toluene, and benzene, is of particular importance. For example mixtures serving as a source of styrene containing feedstock for the process may contain about 55 to about 99.8 weight percent styrene, about 0 to about 50 weight percent ethylbenzene and/or about 0 to about 25 weight percent toluene and benzene.

Generally acetylenic impurities described in this invention are expressed by the formula

R—C_C—R′

where R is an aryl moiety of 6 or 10 carbon atoms, and R′ is hydrogen or a hydrocarbon group of up to 4 carbon atoms, preferably R is a phenyl moiety.

Optionally, it may be desired to treat the impure aromatic monomers stream used in the process of the present invention to remove any carbon monoxide. The amount of carbon monoxide in the liquid mixture should suitably be reduced to below 10 parts per million by weight, preferably below 2 parts per million by weight and most preferably below 1 parts per million by weight, prior to contact with the adsorbent. Similarly, it may be desirable to have low levels of dihydrogen in the feedstream to the adsorber for removal of contained acetylenically unsaturated aromatic impurities.

Any mercury-containing, arsenic-containing, and sulfur-containing components, e.g., hydrogen sulfide, present in the gaseous mixture fed to the particulate bed of adsorbent should suitably be removed therefrom in any known manner in order to avoid the risk of poisoning the dispersed metal. The hydrocarbon mixture used in the process of the present invention is suitably a product of dehydrogenation.

In preferred embodiments of processes according to the invention, the aromatic monomer in the mixture being purified is predominantly styrene, divinylbenzene, vinyl toluene, t-butyl styrene, p-methylstyrene or n-propylbenzene. For example, crude styrene typically contains less than about 1000 parts per million by weight of phenylacetylene. Preferably a crude styrene feedstock contains from about 100 to about 1000 parts per million by weight of phenylacetylene, more preferably from about from about 100 to about 500 parts per million by weight of phenylacetylene based upon the weight of styrene present.

Particularly suitable mixtures serving as a source of styrene containing feedstock for processing according to the invention, contain about 55 to about 75 weight percent styrene, about 20 to about 40 weight percent ethylbenzene and a balance of toluene and optionally benzene. The fluid mixture, while passing through the bed, is at temperatures in a range upward from about negative 5° C. to about 100° C., preferably in a range of from about 5° C. to about 75° C., and more preferably in a range of from about 10° C. to about 65° C.

Broadly, according to the present invention, there is provided a particulate bed of adsorbent comprising predominantly a support material having high surface area on which is dispersed at least one metallic element selected from the group consisting of chromium, iron, cobalt, nickel, copper, ruthenium, palladium, silver and platinum. Suitable adsorbents exhibit, in the presence of an olefinic mixture of gasses within the bed, selective adsorption and/or complexing of the acetylenic impurities with the adsorbent. According to the present invention dispersed metal content is in a range of from about 0.01 to about 40 percent based on the total weight of the adsorbent. Preferably dispersed metal content is in a range of from about 0.01 to about 20 percent based on the total weight of the adsorbent.

The adsorbent can, optionally, further comprise one or more elements selected from the group consisting of lithium, sodium, potassium, zinc, molybdenum, tin, tungsten, and iridium, dispersed on the support material. Preferably the adsorbent further comprises a member selected from the group consisting of lithium, sodium, potassium, zinc, molybdenum, and tin dispersed on the support material.

For processes according to invention the metal dispersed on the support material is, advantageously, at least one element selected from the group consisting of chromium, iron, cobalt, nickel, copper, ruthenium, palladium, silver and platinum, and the absorbent has a dispersed metal content in a range of from about 0.05 to about 20 percent based on the total weight of the adsorbent.

More preferred for processes according to this invention are adsorbents having palladium metal dispersed on the support, and the absorbent has a palladium content in a range of from about 0.05 to about 10 percent, more preferred palladium content in a range of from about 0.1 to about 5.0 percent based on the total weight of the adsorbent.

High metal dispersion and loading resulted in higher metal surface area. Capacity of an adsorbent is, typically, related directly to metal surface area. Any method which increases and/or maintains high metal surface area is, therefore, beneficial to achieving high acetylene adsorption capacity.

Preferred for processes according to this invention are adsorbents having a dispersion value of at least about 10 percent, preferably in a range upward from about 20 percent to about 100 percent. Dispersion is a measure of the accessibility of the active metals on the adsorbent. Such dispersion methods are discussed in H. C. Gruber's, Analytical Chemistry, Vol. 13, p. 1828, (1962). The adsorbents for use in this invention were analyzed for dispersion using a pulsed carbon monoxide technique as described in more detail in the Examples. Palladium containing adsorbents having large dispersion values are desired because more of the palladium metal is available for adsorption.

Support materials are, advantageously, selected from the group consisting of alumina, silica, carbon, clay and zeolites (molecular sieves). Surface areas of support materials are, preferably, in a range of from about 10 to about 2,000 square meters per gram as measured by the BET gas adsorption method.

Generally, the term “molecular sieve” includes a wide variety of positive-ion-containing crystalline materials of both natural and synthetic varieties. They are generally characterized as crystalline aluminosilicates, although other crystalline materials are included in the broad definition. The crystalline aluminosilicates are made up of networks of tetrahedra of SiO₄ and AlO₄ moieties in which the silicon and aluminum atoms are cross-linked by the sharing of oxygen atoms. The electrovalence of the aluminum atom is balanced by the use of positive ions, for example, alkali-metal or alkaline-earth-metal cations.

Zeolitic materials, both natural and synthetic, useful herein have been demonstrated in the past to have catalytic capabilities for many hydrocarbon processes. Zeolitic materials, often referred to as molecular sieves, are ordered porous crystalline aluminosilicates having a definite structure with large and small cavities interconnected by channels. The cavities and channels throughout the crystalline material are generally uniform in size allowing selective separation of hydrocarbons. Consequently, these materials in many instances have come to be classified in the art as molecular sieves and are utilized, in addition to the selective adsorptive processes, for certain catalytic properties. The catalytic properties of these materials are also affected, to some extent, by the size of the molecules which are allowed selectively to penetrate the crystal structure, presumably to be contacted with active catalytic sites within the ordered structure of these materials.

In the past various molecular sieve compositions natural and synthetic have been found to be useful for a number of hydrocarbon conversion reactions. Among these are alkylation, aromatization, dehydrogenation and isomerization. Among the sieves which have been used are Type A, X, Y and those of the MFI crystal structure, as shown in “Atlas of Zeolite Structure Types,” Second Revised Edition 1987, published on behalf of the Structure Commission of the International Zeolite Associates and incorporated by reference herein. Representative of the last group are ZSM-5 and AMS borosilicate molecular sieves.

Prior art developments have resulted in the formation of many synthetic crystalline materials. Crystalline aluminosilicates are the most prevalent and, as described in the patent literature and in the published journals, are designated by letters or other convenient symbols. Exemplary of these materials are Zeolite A (Milton, in U.S. Pat. No. 2,882,243), Zeolite X (Milton, in U.S. Pat. No. 2,882,244), Zeolite Y (Breck, in U.S. Pat. No. 3,130,007), Zeolite ZSM-5 (Argauer, et al., in U.S. Pat. No. 3,702,886), Zeolite ZSM-11 (Chu, in U.S. Pat. No. 3,709,979), Zeolite ZSM-12 (Rosinski, et al., in U.S. Pat. No. 3.832,449), and others.

Manufacture of the ZSM materials utilizes a mixed base system in which sodium aluminate and a silicon containing material are mixed together with sodium hydroxide and an organic base, such as tetrapropylammonium hydroxide and tetrapropylammonium bromide, under specified reaction conditions, to form the crystalline aluminosilicate, preferably a crystalline metallosilicate exhibiting the MFI crystal structure.

A preferred class of molecular sieves useful, according to the present invention, are crystalline borosilicate molecular sieves disclosed in commonly assigned U.S. Pat. No. 4,268,420, U.S. Pat. No. 4,269,813, U.S. Pat. No. 4,292,457, and U.S. Pat. No. 4,292,458 to Marvin R. Klotz, which are incorporated herein by reference.

### BRIEF DESCRIPTION OF PREFERRED EMBODIMENTS OF THE INVENTION

While this invention is susceptible of embodiment in many different forms, this specification disclose only some specific forms as an example of the use of the invention. In particular, preferred embodiments of the invention for purification of aromatic monomers such as are typically produced by dehydrogenation of suitable benzenoid hydrocarbons, by passing a steam of ethylenically unsaturated aromatic monomer and impurities comprising at least one substituted aromatic compound having the same or similar carbon content in which a substituent moiety is acetylenically unsaturated are described. The invention is not intended to be limited to the embodiments so described, and the scope of the invention will be pointed out in the appended claims.

More specifically described is an integrated styrene purification system including: one or more optional heat exchangers for controlling temperature of the gaseous feedstream to temperatures in a range from about 5° C. to about 75° C., adsorption vessels containing particulate beds of a suitable solid adsorbents, and means for analysis of feed and effluent streams, such as an on-line analytical system.

During operation of the integrated purification system, a fluid mixture containing less than about 500 parts per million by weight of the phenylacetylene and carbon monoxide impurities formed by chemical conversions in commercial dehydrogenation processes, is, for example crude styrene fed from the overhead of a distillation tower or intermediate storage through a feed exchanger to control temperature during adsorption. Effluent from the feed exchanger flows through the adsorption vessels which contain beds of a suitable solid adsorbents.

During operation the fluid mixture passes though the bed of particulate adsorbent at liquid hourly space velocities in a range of from about 0.5 hours⁻¹ to about 50 hours⁻¹ and even higher, preferably at gas hourly space velocities in a range of about 1.0 hours⁻¹ to about 30 hours⁻¹.

Compositions of the liquid feed and effluent of each adsorption vessel is monitored by on-line analytical system. While levels of a selected impurity, e.g. phenylacetylene, in the effluent from the adsorption vessel in purification service are in a range downward from a predetermined level, the effluent flows directly to pipeline for transportation of polymer grade styrene, or to storage. When the level of the selected impurity in the effluent of a vessel in purification service reaches or exceeds the predetermined level, that adsorption vessel is isolated from the process flow, and thereafter the resulting bed of loaded adsorbent is treated to effect release of the contained impurities from the adsorbent by treatment with a reducing gas. Advantageously the resulting bed of adsorbent is thereafter regenerated in the presence of a reducing gas comprising dihydrogen and containing at less than about 0.1 parts per million of carbon monoxide, to effect release of the contained impurities from the adsorbent

Suitable absorbents for used in the first zone have capacity to treat from about 300 to about 40,000 pounds of olefin feed per pound of adsorbent where the olefin feed contains about 0.5 parts per million (ppm) acetylenic impurities. Approximately 5×10⁻⁴ pounds of acetylenic impurities to about 1×10⁻² pounds are, advantageously, adsorbed per pound of adsorbent before regeneration is required.

During continuous operation of this embodiment, the time required for treating, alternately, of the loaded adsorbent to effect release of the contained acetylenic impurities from the adsorbent by hydrogenation, is provided by using two or more independent adsorption vessels containing beds.

Surface area of adsorbents can be determined by the Brunaur-Emmett-Teller (BET) method or estimated by a simpler Point B method. Adsorption data for nitrogen at the liquid nitrogen temperature, 77 K, are usually used in both methods. The Brunaur-Emmett-Teller equation, which is well known in the art, is used to calculate the amount of nitrogen for mono-layer coverage. The surface area is taken as the area for mono-layer coverage based on the nitrogen molecular area, 16.2 square Angstroms, obtained by assuming liquid density and hexagonal close packing. In the Point B method, the initial point of the straight portion of the Type II isotherm is taken as the completion point for the mono-layer. The corresponding amount adsorbed multiplied by molecular area yields the surface area.

Dispersion and surface area of active metal sites was determined by carbon monoxide chemisorption using a Pulse Chemisorb 2700 (Micromeritics). In this procedure, approximately 4 gram samples were purged with helium carrier gas, calcined in air at 500° C. for 1 hr, purged with helium, reduced in hydrogen at 500° C., purged with helium, and cooled to room temperature. The sample was treated with 49.5 percent carbon monoxide in helium and the dosed with 0.045 mL pulses of 49.5 percent carbon monoxide (CO), balance nitrogen, and the carbon monoxide uptake was measured by a thermal conductivity cell. Palladium dispersion values were calculated assuming one carbon monoxide molecule per palladium atom. Palladium loadings are weight percent palladium metal.

In characterizing the pore volume, both total pore volume and its distribution over the pore diameter are needed. The total pore volume is usually determined by helium and mercury densities or displacements. Helium, because of its small atomic size and negligible adsorption, gives the total voids, whereas mercury does not penetrate into the pores at ambient pressure and gives inter-particle voids. The total pore volume equals the difference between the two voids.

Palladium on a high-surface-area γ-Al₂O₃ is a preferred adsorbent for purification of olefins in accordance with this invention. In order to introduce palladium and/or other suitable metal ions on a high-surface-area γ-Al₂O₃, any known technique for monolayer dispersion can be employed. The phenomenon of spontaneous dispersion of metal oxides and salts in monolayer or submonolayer forms onto surfaces of inorganic supports with high surface areas has been studied extensively in the literature (e.g., Xie and Tang, 1990).

### EXAMPLES OF THE INVENTION

The following Examples will serve to illustrate certain specific embodiments of the herein disclosed invention. These Examples should not, however, be construed as limiting the scope of the novel invention as there are many variations which may be made thereon without departing from the spirit of the disclosed invention, as those of skill in the art will recognize.

General

In these examples of the invention, the source of styrene monomer contained about 62 percent styrene and 38 percent ethylbenzene. The phenylacetylene concentration in the styrene monomer was about 125 ppm by weight.

Except were otherwise stated, adsorbent used for the examples was 0.46 percent palladium on alumina, 3.2 mm spheres, Model 20, 574S which was supplied by Aldrich Chemical Company, Inc. Milwaukee, Wis. USA.

A tubular 410 stainless steel reactor with a nominal ID of ¾ inch was loaded with 100 mL (20 gams) of the 0.46 percent Aldrich palladium-on-alumina material. This amount provided a bed length of about 16 inches. Alumina balls served as underlay and overlay support.

Except were otherwise stated, runs were conducted in a plug-flow mode at a reactor temperature of 50° C., ambient pressure, and initial feed rate of 50 cc/hr (about 1.2 LHSV). Temperature in the reactor was controlled by a Haake bath which circulates a 50/50 mixture of ethylene glycol and water from its reservoir and into the copper tubing wrapped around the reactor.

Pretreatment of the palladium-on-alumina material was as follows: First, the reactor content was purged with nitrogen for 30 minutes, this purge was followed by a hydrogen purge for at least 12 hours at a rate of 400 cc/min.

To start a run, flow of styrene monomer through the reactor was established. The flow rate was measured with a bubble meter. Periodically, a portion of the effluent was injected into a gas chromatograph. Concentrations of the components were then determined. After the impurity had broken through the adsorbent (defined as 1 PPM measured on the GC trace), one or two additional GC samples are taken and the impurity levels are determined. These data were plotted on a graph of impurity concentration versus time. The concentration of the impurity was then extrapolated back to the zero impurity to determine the time-to-breakthrough. The amount of adsorbed impurity is then calculated from the feed flow rate, the concentration of the impurity in the feed stream, and the time to breakthrough as determined above

After complete adsorption of phenylacetylene from styrene, regeneration of the palladium-on-alumina material was as follows: First, the reactor was flushed with ethylbenzene to wash off impurities and then, purging the palladium-on-alumina material bed with hydrogen for at least 12 hours. This treatment with hydrogen catalytically hydrogenated the phenylacetylene on the palladium-on-alumina material to ethylbenzene/styrene. For safety reasons, the hydrogen-enriched adsorbent bed was purged with nitrogen for about 30 minutes before another run was started. Then the feed pump was restarted and samples taken at periodic intervals until a breakthrough point is achieved. This is the point where the bed had reached its fall adsorption capacity and hence, a slow rise in the phenylacetylene concentration was observed.

Through all the runs, no unknown compounds were formed during the entire adsorption cycle.

### Example 1

This example illustrated the essential role of temperature. In this run, the temperature of the reactor was ambient, and feed rate of was at 50 cc/hr. After 2 hours of pumping feed through the adsorbent bed, phenylacetylene concentration was reduced from 125 ppm to 40 ppm.

### Example 2

After the Example 1 run, the temperature of the reactor was adjusted to 50° C. During about 3.75 hours of passing styrene through the reactor, complete removal of phenylacetylene was observed. After an overnight shutdown, another sample was collected which still showed that no phenylacetylene present. A breakthrough of phenylacetylene (31 ppm) was achieved after 4.75 hours on stream. The adsorption capacity was 0.0004 gm phenylacetylene/gm palladium. By comparison with the Example 1 run at ambient temperature with the same the palladium-on-alumina bed, it appears that phenylacetylene adsorption was significantly better at higher temperatures. The palladium-on-alumina bed was then flushed with ethylbenzene for one hour at 50° C. and regenerated with dihydrogen at a rate of 400 cc/min for an entire weekend.

### Example 3

After the weekend, flow of hydrogen was stopped. After a 30-minute nitrogen purge, styrene feeding to the reactor was resumed. An initial grab sample showed no phenylacetylene content, which indicated successful regeneration of the palladium. No breakthrough was achieved during the first 4.75 hours on stream. The feed rate was increased from 50 cc/hr to 75 cc/hr (1.8 LHSV). Thereafter, in just 65 minutes, a breakthrough occurred at 10-ppm phenylacetylene concentration and a total of 79 mL. of styrene. The adsorption capacity was 0.0006 gm phenylacetylene/gm adsorbent, which is beneficially higher than the 0.0004 gm phenylacetylene/gm adsorbent of Example 2. As in Example 2, the reactor was filled at day's end, and the reactor temperature maintained at 50° C. overnight.

### Example 4

Again, a sample was taken from the filled reactor which acted as a holding tank overnight. For the second time, phenylacetylene was not detected in the styrene product, an indication that adsorption can occur both in static and dynamic conditions. When pump was restarted at 75 cc/hr, breakthrough was attained in 66 minutes with a phenylacetylene content of 11 ppm and again after passing 79 mL of styrene. The adsorption capacity in this particular run is 0.0007 gm phenylacetylene/gm adsorbent.

Total removal of phenylacetylene from styrene by adsorption has been successfully demonstrated in these Examples of the invention. Phenylacetylene adsorption with palladium-on-alumina material was advantageously carried out at elevated temperatures. Also, regeneration of the palladium-on-alumina material was successfully demonstrated.

### Example 5

The adsorbent medium used in this example was a 0.4 percent palladium on alumina which was supplied by Engelhard Corporation, Iselin, N.J. USA. The concentration of phenylacetylene in crude styrene was 125 ppm. The experiment was carried out by soaking 10 grams of 0.4% palladium-on-alumina material which had been reduced by treatment with dihydrogen, in 50 grams of crude styrene at room temperature (less than 20° C.). After thorough mixing of the palladium-on-alumina and styrene with the aid of a spin bar, one mL. of samples were taken at intervals for GC analysis. The data are shown in Table 1. Phenylacetylene was not detected after 48 hours. The adsorption capacity of 0.4 percent palladium-on-alumina material in this example was 0.0006 gm phenylacetylene/gm adsorbent. This demonstrated phenylacetylene adsorption from crude styrene in a static/batch mode.

TABLE 1

| Elapsed Time, hr. | Phenylacetylene Level, ppm |
|---|---|
| 0 | 125 |
| 1 | 94 |
| 2 | 72 |
| 4 | 52 |
| 18 | 36 |
| 24 | 7 |
| 48 | 0 |

Examples have been presented and hypotheses advanced herein in order to better communicate certain facets of the invention. The scope of the invention is determined solely by the scope of the appended claims.

For the purposes of the present invention, “predominantly” is defined as more than about fifty per cent. “Substantially” is defined as occurring with sufficient frequency or being present in such proportions as to measurably affect macroscopic properties of an associated compound or system. Where the frequency or proportion for such impact is not clear substantially is to be regarded as about twenty per cent or more. The term “Essentially” is defined as absolutely except that small variations which have no more than a negligible effect on macroscopic qualities and final outcome are permitted, typically up to about one percent.

That which is claimed is:

1. A process for purification of an aromatic monomer such as is produced by catalytic dehydrogenation of an alkylated aromatic compound which process comprises:
providing a feedstock comprising at least one substituted aromatic monomer of from 8 to about 18 carbon atoms in which a substituent moiety is ethylenically unsaturated and impurities comprising at least one substituted aromatic compound having the same or similar carbon content in which a substituent moiety is acetylenically unsaturated in an amount of more than about 100 parts per million based upon the total amount of aromatic monomer present and optionally saturated hydrocarbon compounds;
passing the feedstock through a particulate bed of adsorbent comprising predominantly a support material having high surface area on which is dispersed at least one metallic element in the zero valent state selected from the group consisting of chromium, iron, cobalt, nickel, copper, ruthenium, palladium, silver and platinum, to effect, under conditions suitable for adsorption within the bed, to effect, in the presence of an essentially dihydrogen-free atmosphere within the bed, selective adsorption and/or complexing of the contained impurities with the adsorbent, and thereby obtain purified effluent which contains less than about 100 parts per million of the acetylenically unsaturated impurity; and
thereafter regenerating the resulting bed of adsorbent in the presence of a reducing gas comprising dihydrogen to effect release of the contained impurities from the adsorbent.

2. The process according to claim 1 wherein the aromatic monomer is selected from the group consisting of styrene, n-propylbenzene, divinylbenzene, vinyl toluene, t-butyl styrene and p-methylstyrene.

3. The process according to claim 1 wherein the support is a material selected from the group consisting of alumina, silica, active carbon, clay and zeolites, and has surface area in a range of from about 10 to about 2,000 square meters per gram as measured by the BET gas adsorption method.

4. The process according to claim 3 wherein the metal dispersed on the support material is at least one element selected from the group consisting of iron, cobalt, nickel, copper, palladium, silver and platinum, and the absorbent has a dispersed metal content in a range of from about 0.01 to about 10 percent based on the total weight of the adsorbent.

5. The process according to claim 4 wherein the liquid mixture passes though the bed of particulate adsorbent at liquid hourly space velocities in a range of from about 0.5 hours⁻¹ to about 50 hours⁻¹.

6. The process according to claim 1 wherein the adsorbent comprises at least about 90 weight percent of a gamma alumina having surface area in a range of from about 80 to about 500 square meters per gram as measured by the BET gas adsorption method.

7. The process according to claim 6 wherein the metal dispersed on the support material is palladium, and the absorbent has a palladium content in a range of from about 0.01 to about 10 percent based on the total weight of the adsorbent.

8. The process according to claim 1 wherein the aromatic monomer in the liquid mixture being purified is predominantly an aromatic monomer selected from the group consisting of styrene and vinyl toluene, the liquid mixture contains less than about 0.5 parts per million by volume of hydrogen and less than about 1 parts per million by volume of mercury-containing, arsenic-containing, and sulfur-containing components, each calculated as the element, and wherein the gaseous mixture, while passing through the bed, is at temperatures in a range of from about 5° C. to about 75° C.

9. The process according to claim 8 wherein the adsorbent comprises at least about 90 weight percent of a gamma alumina having surface area in a range of from about 150 to about 350 square meters per gram as measured by the BET gas adsorption method, and wherein the metal dispersed on the support material is palladium, and the absorbent has a palladium content in a range of from about 0.01 to about 10 percent based on the total weight of the adsorbent.

10. The process according to claim 1 wherein the adsorbent has a metal dispersion value of at least 10 percent as measured by carbon monoxide chemisorption method.

11. A process for recovery of a high purity styrene monomer from a feedstock produced by catalytic dehydrogenation of ethylbenzene which process comprises:
passing a feedstock comprising predominantly styrene and impurities comprising phenyacetylene in an amount of more than about 100 parts per million based upon the total amount of styrene present and optionally ethylbenzene through a particulate bed of adsorbent comprising predominantly a support material selected from the group alumina, silica, active carbon, clay and zeolites having surface area in a range of from about 10 to about 2,000 square meters per gram as measured by the BET gas adsorption method, on which is dispersed at least one metallic element selected from the group consisting of chromium, iron, cobalt, nickel, copper, ruthenium, palladium, silver and platinum, to provide an effluent stream from the bed;
effecting, in the presence of an essentially dihydrogen-free atmosphere within the bed, selective and reversible adsorption and/or complexing of the contained impurities with the adsorbent, until levels of the phenyacetylene impurity in the effluent stream increase to a predetermined level in a range downward from about 20 parts per million by volume; and
thereafter regenerating the resulting bed of adsorbent in the presence of a reducing gas comprising dihydrogen to effect release of the contained impurities from the adsorbent.

12. The process according to claim 1 wherein the aromatic monomer is selected from the group consisting of styrene, n-propylbenzene, divinylbenzene, vinyl toluene, t-butyl styrene and p-methylstyrene.

13. The process according to claim 11 wherein the support is a material selected from the group consisting of alumina, silica, carbon clay and zeolites, and has surface area in a range of from about 10 to about 2,000 square meters per gram as measured by the BET gas adsorption method.

14. The process according to claim 13 wherein the metal dispersed on the support material is at least one element selected from the group consisting of iron, cobalt, nickel, zinc, ruthenium, palladium, platinum, and potassium, and the absorbent has a dispersed metal content in a range of from about 0.01 to about 10 percent based on the total weight of the adsorbent.

15. The process according to claim 14 wherein the liquid mixture passes though the bed of particulate adsorbent at liquid hourly space velocities in a range of from about 1.0 hour⁻¹ to about 30 hours⁻¹.

16. The process according to claim 11 wherein the adsorbent comprises at least about 90 weight percent of a gamma alumina having surface area in a range of from about 80 to about 500 square meters per gram as measured by the BET gas adsorption method, and contains less than 500 parts per million by weight of a sulfur-containing component, calculated as elemental sulfur.

17. The process according to claim 16 wherein the metal dispersed on the support material is palladium, and the absorbent has a palladium content in a range of from about 0.01 to about 10 percent based on the total weight of the adsorbent.

18. The process according to claim 11 wherein the olefin in the gaseous mixture being purified is predominantly ethylene or propylene, the gaseous mixture contains less than about 0.5 parts per million by volume of hydrogen and less than about 1 parts per million by volume of mercury-containing, arsenic-containing, and sulfur-containing components, each calculated as the element, and wherein the gaseous mixture, while passing through the bed, is at temperatures in a range of from about 5° C. to about 75° C.

19. A process for recovery of a high purity aromatic monomer from a feedstock produced by catalytic dehydrogenation of an alkylated benzene which process comprises:
passing a feedstock comprising at least about 98 percent by volume of an aromatic monomer selected from the group consisting of styrene, methyl phenyl ethylene, vinyl toluenes, vinyl chlorobenzene, t-putylbenzene, n-propylbenzene and divinylbenzene, and dehydrogenated impurities comprising one or more members of the group consisting of phenylacetylene, methyl phenylacetylene, tolylacetylene, (vinylphenyl)acetylene, chloracetylene and t-butylphenyl)acetylene in an amount of about 100 to about 1000 parts per million based upon the total amount of monomer present through a particulate bed of adsorbent comprising predominantly through a bed of adsorbent which is free of a substantial amount of carbon monoxide, the adsorbent comprising at least about 90 weight percent of gamma alumina having surface area in a range of from about 150 to about 350 square meters per gram as measured by the BET gas adsorption method, on which is dispersed is at least one element selected from the group consisting of iron, cobalt, nickel, copper, palladium, silver and platinum, in the zero valent state, to effect, under conditions suitable for adsorption within the bed, selective adsorption and/or complexing of the contained impurities with the adsorbent, thereby obtaining an effluent steam of feedstock which contains less than about 10 parts per million by volume of the dehydrogenated impurities;
effecting, in the presence of an essentially dihydrogen-free atmosphere within the bed, selective adsorption and/or complexing of one or more of the contained impurities with the adsorbent, until levels of the impurities in the effluent stream increase to a limiting level in a range downward from about 10 parts per million by weight; and
thereafter regenerating the resulting bed of adsorbent in the presence of a reducing gas comprising dihydrogen which reducing gas is free of a substantial amount of carbon monoxide, to effect release of the impurities from the adsorbent.

20. The process according to claim 18 wherein the adsorbent comprises at least about 90 weight percent of a gamma alumina having surface area in a range of from about 150 to about 350 square meters per gram as measured by the BET gas adsorption method, the metal dispersed on the support material is palladium, and the absorbent has a palladium content in a range of from about 0.01 to about 10 percent based on the total weight of the adsorbent, and wherein the gaseous mixture, while passing through the bed, is at temperatures in a range of from about 5° C. to about 50° C.
